(19) United States
(12) Patent Application Publication
(10) Pub. No.: US 2013/0251594 A1
(43) Pub. Date: Sep. 26, 2013

(54) Sol-Gel Based Optical Chemical Sensor For Detection of Organophosphates and Method For Preparation Thereof

(71) Applicant: Aleksandra Lobnik, Hoce (SI)

(72) Inventor: Aleksandra Lobnik, Hoce (SI)

(21) Appl. No.: 13/989,529

(22) PCT Filed: Nov. 25, 2011
(86) PCT No.: PCT/SI11/00068

§ 371 Date: May 24, 2013

(30) Foreign Application Priority Data
Nov. 26, 2010 (SI) P-201000405

(51) Int. Cl. G01N 21/64

(52) U.S. Cl. CPC G01N 21/64
USPC 422/82.08; 427/601

(57) ABSTRACT

The present invention solves the technical problem of manufacturing process and design of optical chemical sensor, in which interaction of the indicator with the analyte allows quick and reliable spectrofluorimetric determination of organophosphates. The procedure for creation an optical chemical sensor with sol-gel membrane for detection of organophosphates, is characterized in that it begins with the preparation of the membrane so that the indicator C1, which is dissolved in ethanol (10⁻⁷ M), add tetraethoxysilane (TEOS) and methyltriethoxysilane (MTriEOS) and stirr in an ultrasonic bath for 10 minutes; to then add the catalyst solution (0.001 M HCI) and mix again in an ultrasonic bath for 20 minutes; to make coatings on the glass slides after 24 h of sol aging in a closed container at room temperature and so that the slide is dipped in the sol and slowly pulled out from it, and let to dry for 24 hours at room temperature to form a membrane; to wipe coating on one side slides before drying.

### TECHNICAL AREA

The subject of the invention covers the area of optical chemical sensors, which are sensitive to organophosphate

### TECHNICAL PROBLEM

The technical problem is the method of manufacture and design of optical chemical sensor, in which the interaction between the analyte and the indicator allows quick and reliable spectrofluorimetric measurement of organophosphates. The interaction is reflected in the optical properties of the indicator, which shows the change in its fluorescence intensity. The task of the invention is also a modification of the method for the preparation of sensor membranes, which will enable the preparation of a sensor membrane that will be transparent, without cracks, permeable for the analyte, from which there will be no leaching of the indicator and no deactivation of the indicator after its immobilization.

Due to the increasing environmental burden with various noxious chemicals there is an increasing need for simple and effective monitoring of the environment. For the determination of pollutants the instrumental methods are largely used. These procedures require long pre-treatment times and expensive apparatus, qualified personnel and do not allow continuous monitoring or use in remote locations. A suitable alternative to the above instrumental methods are chemical sensors, if they achieve sufficient selectivity and sensitivity. Besides, they allow the measurement be performed on site (“in situ”) and give results within a short time. These systems allow real time control of discharges of pollutants and, simultaneously, reduce the cost of the process of environmental monitoring.

Organophosphates are chemically esters of phosphoric acid and its derivatives. Organophosphates are used as pesticides (phosphamidon, dicrotophos, methamidophos, chlorpyrifos, diazinon, malathion) and as nerve poisons (sarin, soman, tabun, VX). Some less toxic organophosphates are used as solvents, plasticizers and as additives in extreme pressure in the engines. Biologically functioning organophosphates are cholinesterase inhibitors. The use of organophosphate pesticides has greatly increased, mainly due to the abolition of persistent organochlorinated pesticides. Despite the fact that organophosphate pesticides degrade relatively rapidly in the presence of sunlight, air and soil, small amounts of these pesticides are still moving in the food and drinking water. According to the World Health Organization (WHO) on average each year 3 million people poison with organophosphate, of whom around 220,000 die. Because of their toxicity and their increasingly frequent occurrence in our environment, the need to develop simple and rapid sensor system for “in-situ” determination of organophosphates in low concentrations is necessary.

### STATE OF THE ART

Chemical sensors as scale down analytical devices are known, which provide continuous and reversible information on the chemical concentration. The sensor is typically composed of receptor for the analyte recognition and of a conversion element, which is connected to the display and shows the presence of the analyte. Given the nature of the converter, chemical sensors can be divided into optical, electrochemical, electrical, magnetic and termometric.

The receptor function is in most cases performed by a thin film that can react with the analyte molecules, catalyze selective reactions or participate in chemical equilibrium with the analyte. In the case of optical chemical sensors the result of interactions between receptor and analyte is the change in the receptor optical properties, such as absorption, luminescence and reflection. The task of the converter is to convert the optical response of the receptor into a measurable signal, for example voltage and/or stream.

In the patent applications US2002102629, W002079763 and US2002142472 biosensors for determination of organophosphates, where green algae and cyanobacteria were used as indicators are described. Sensing principle is based on the measurement of organophosphates quantum efficiency changes.

The file patent US2010227766 describes the preparation and determination of organophosphates with sensors prepared from a carboxylic aminofluorescein immobilized on functionalized polymeric microspheres covered with poly (2 -vinilpiridinom).

In the European Patent No. 0585212 B1, the preparation of sensor membranes from different polymers, cellulose, ethyl acetate and polystyrene is described.

In the Slovenian Patent No. 21110 the method and an optical sensor for continuous measurement of dissolved hydrogen peroxide, with an emphasis on the sol-gel membranes in sensing purposes is described.

### DESCRIPTION OF TECHNICAL PROBLEM SOLUTION

The essence of an optical chemical sensor with sol-gel membrane for detection of organophosphates of the invention lies in the fact that the sensor active part is the thin membrane, in which the indicator Coumarin 1 is immobilized. The indicator plastic carrier is the sol-gel material, which is based on a combination of alkoxysilane

(TEOS) and an organically modified siloxane (MTriEOS). The reaction of the indicator, immobilized in sol-gel membrane, with diethyl chlorophosphate (DCP) organophosphate is reflected in the optical changes that are detected as a change in fluorescence intensity as a function of analyte concentration. The optical change is monitored by the photodetector.

Manufacturing process and design of optical chemical sensor with sol-gel membrane for detection of organophosphates will be described below in more detail through pictures, which show:

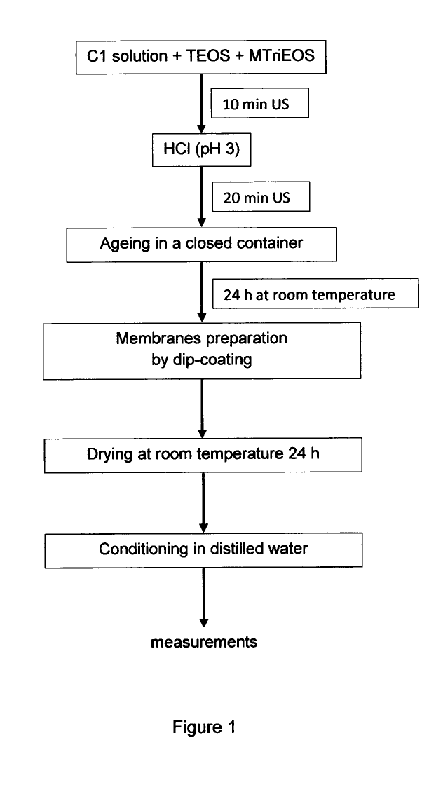

FIG. 1—sol-gel membrane sensor manufacturing process

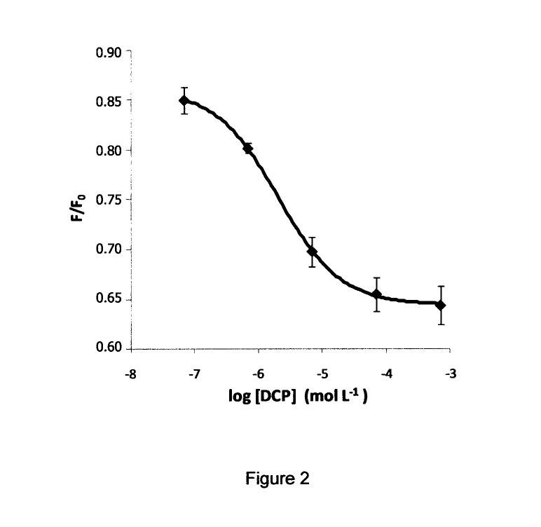

FIG. 2—dependence of the sensor membrane fluorescence intensity of organophosphate concentrations

The active part of the optical chemical sensor with sol-gel membrane for detection of organophosphates is a thin membrane in which is immobilized the indicator Coumarin 1.

As an indicator polymeric carrier the sol-gel material was selected, which is hydrophobic by its nature, and is chemically, photo-chemically, thermally and mechanically stable, so it can also be used in more severe conditions. Is optically transparent up to 250 nm and have low own fluorescence. Its swelling in organic and aqueous solutions is negligible. By controlling of process parameters, such as pH, type and concentration of the sol-gel precursor, the amount of water, drying conditions, type of solvent in combination with aging sol and sol-gel material the microporosity and polarity of the sol-gel can be influenced. As precursurs to produce membranes, in addition to alkoxysilane (TEOS) we selected organic modified siloxane (MTriEOS), which reduces the number of surface silanol groups and increases gels flexibility and lowers the level of crosslinking. For the indicator, we chose Coumarin 1, because it showed good sensitivity to the analyte in the lower concentration range (10 nM to 100 nM), it is photostabile and commercially available.

To identify organophosphates primarily fluorescent indicators, such as phenylpyridine dyes, antrazine bisimide dyes, aminoflurescein, pyrene dyes, lanthanide complexes and coumarin dyes are used. Absorption indicators, such as, nitrophenylamine derivatives are less used. The overall reaction mechanism, which is exploited by the chemical sensors for the detection of organophosphates, mimics the chemical reactions of acetylcholinesterase inhibition with organophosphate. It involves a reaction between the nucleophilic indicator and the electrophilic organophosphate analyte. The reaction product is the phosphate ester, which causes a change in fluorescence. For the invention for an optical chemical sensor a coumarin dye 7-diethylamino-4-methylcoumarin (C1) was chosen. The interaction with the analyte changes the optical properties of the dye, through which the indirect measure of the concentration of the analyte is possible. The dye has a high quantum efficiency, good photostability and is commercially available.

For the preparation of stable transparent membranes, we studied the sol-gel solution with different TEOS and MTriEOS molar ratios (1:0, 9:1, 4:1, 3:1, 1:1, 1:3, 1:4, 1:9, 0:1). We also studied the effect of Triton X, which is an anionic surfactant, molar ratios between ethanol and precursors (10:1, 20:1, 30:1, 40:1), molar ratios between water and precursors (4:1, 15:1), sol ageing time (1, 2, 6, 10, 30 days), drying conditions (at room temperature, in desiccator with silica gel, at 70° C. for 4 h) and time of solution mixing (20 and 40 min in the ultrasonic bath (US)) on the sol-gel membrane quality. Stable and transparent membranes were obtained by using the molar ratio between water and precursor 4:1, molar ratio between TEOS and MTriEOS 1:1 and molar ratio between solvent (ethanol) and precursors 40:1, therefore these conditions were used for further research.

The creation of an optical chemical sensor with sol-gel membrane for detection of organophosphates is shown in FIG. 1 and begins with the preparation of the membrane so that to the indicator C1, which is dissolved in ethanol (10⁻⁷ M), is added tetraethoxysilane (TEOS) and methyltriethoxysilane (MTriEOS) and stirred in an ultrasonic bath for 10 minutes. Then the catalyst (0.001 M HCl) is added to the solution and again mixed in an ultrasonic bath for 20 minutes. As a solid supports, glass slides were used, which were previously activated by soaking in concentrated nitric (V) acid for 24 hours, rinsing with distilled water and ethanol and drying for 3 hours at 100 ° C. Coatings on glass slides are prepared after 24 hours of sol ageing in a closed container and at room temperature. The glass slides are dip-coated in sol and slowly pulled out from it. The membranes are let to dry for 24 hours at room temperature. Before drying the coating is wiped from the one side glass slide. This is followed by 24 hours of sol aging and 24 hours drying, followed by conditioning in distilled water for at least 3 hours before taking measurements.

Reaction of indicator, immobilized in sol-gel membrane, with organophosphate (DCP) is reflected in the optical changes as a change in fluorescence intensity as a function of analyte concentration. Fluorescence was measured on a Perkin Elmer LS 55 spectrofluorometer, which has a xenon lamp light source. For measurements the membranes on slides size 12.8×38 mm square were placed diagonally in a quartz cuvette. During the course of the measurements the membranes were not taken out from the cuvette, but solutions of defined analyte concentrations were added or removed using a syringe.

The graph in FIG. 2 shows the dependence of the fluorescence of the indicator immobilized in sol-gel membrane on the concentration of diethyl chlorophosphate (DCP). F/F₀ represents the ratio of emission intensity in the presence of defined concentrations of the analyte (F) and emission intensity in the absence of analyte (F₀). The relation between analyte concentration and fluorescence intensity can be described by Boltzmann equation:

$$y = \frac{0.86 - 0.6443}{1 + {e}^{\frac{( x + 5.685 )}{0.4849}}} + 0.6443 .$$

The correlation coefficient is 0.9909 in this case. The sensor membrane limit of detection is 0.69 μM. A linear calibration curve concentration range is between 187 nM and 22.8 μM DCP. The response time is 600 s.

Table 1 lists the amount of reagents for the preparation of sensor membranes for the invention.

TABLE 1

| | | Catalyst | C1 |
|---|---|---|---|
| MTriEOS | TEOS | 0.001M HCl | 10⁻⁷M |
| [mmol] | [mmol] | [mol] | [mol] |
| 6.8 | 6.8 | 1 × 10⁻⁶ | 8.2 × 10⁻⁹ |

The procedure for the preparation of optical chemical sensors is realized in a simple preparation of sensor membranes with indicator immobilization in a SiO₂ sol-gel polymer-based material, where the sensor response to organophosphate was determined by measuring the fluorescence intensity and has the limit of detection of 0.69 μM and a linear concentration range between 187 nM and 22.8 μM DCP.

1. The procedure for creation an optical chemical sensor with sol-gel membrane for detection of organophosphates, is characterized in that it begins with the preparation of the membrane so that the indicator C1, which is dissolved in ethanol (10⁻⁷ M), add tetraethoxysilane (TEOS) and methyltriethoxysilane (MTriEOS) and stirr in an ultrasonic bath for 10 minutes; to then add the catalyst solution (0.001 M HCl) and mix again in an ultrasonic bath for 20 minutes; to make coatings on the glass slides after 24 h of sol aging in a closed container at room temperature and so that the slide is dipped in the sol and slowly pulled out from it, and let to dry for 24 hours at room temperature to form a membrane; to wipe coating on one side slides before drying.

2. An optical chemical sensor with sol-gel membrane for detection of organophosphates by the procedure of claim 1, is characterized in that is a sensor membrane designed to use the molar ratio between water and precursors of 4:1, molar ratio between TEOS and MTriEOS of 1:1 and molar ratio between solvent and precursors of 40:1.
